(19) United States
(12) Patent Application Publication
(10) Pub. No.: US 2002/0181801 A1
(43) Pub. Date: Dec. 5, 2002

(54) Feature-based image correction

(76) Inventors: Bradford H. Needham, North Plains, OR (US); Mark Lewis, La Grande, OR (US)

Correspondence Address: PILLSBURY WINTHROP, LLP, P.O. BOX 10500, MCLEAN, VA, 22102, US

(21) Appl. No.: 09/870,984

(22) Filed: Jun. 1, 2001

(51) Int. Cl. G06K 9/40; G06T 5/00; G06T 7/00; G06K 9/46

(52) U.S. Cl. 382/274; 382/190

(57) ABSTRACT

An arrangement is provided for feature-based image correction. In an embodiment, an automatic feature detection unit detects a feature from an input image according to a correction specification and generates a feature description for the detected feature. A feature-based correction unit corrects the input image based on the feature description and the correction specification and generates a corrected image.

### BACKGROUND

Aspects of the present invention relate to digital imaging. Other aspects of the present invention relate to content based digital image processing.

In the era of digital information, more and more data is converted to or created in digital form and image data is no exception. There are many advantages associated with digital data. One of them is the ease of manipulation of such data. For example, with digital images such as digital photographs, videos, etc. (whether created originally in digital form or converted into digital form from other forms), automatic digital manipulation has become common place. For example, the intensity values within a digital image can be changed using software or hardware techniques to enhance underexposed or overexposed digital images.

How and why a digital image is manipulated depends often on the reason for and the expected outcome of the manipulation. For example, if a digital photo has very low contrast (corresponding to a small intensity dynamic range), it can be enhanced through digitally increasing the contrast of the digital photo. This can be achieved by re-scaling the intensity value of every single pixel throughout the entire digital photo based on a larger intensity dynamic range. Such an approach manipulates all the pixels in the digital photo indiscriminately. This re-scaling approach may work well when the cause for poor digital photo quality (e.g., small intensity dynamic range) is responsible for the overall degradation of the entire digital photo.

However, there are various situations in which only portions of a digital image present an undesirable quality. For example, images of people in a back-lit digital photo may appear to be almost completely indiscernible i.e. their faces are dark while the background in the same digital photo may be simultaneously adequate. In this case, only selected portions of the digital photo need to be enhanced and applying such an enhancing operation throughout the entire digital photo may yield an equally, yet different, unsatisfactory outcome. Furthermore, different portions of a digital image may need different types of enhancement. For instance, in a back-lit digital photo, the image of a person's face may be underexposed and the image of the sky may be overexposed. For the former, contrast needs to be improved. For the latter, the brightness of the image of the sky may need to be reduced.

Existing approaches to manipulating digital images to change undesirable aspects of a digital image involve manipulating different portions of the digital image individually and manually. For example, manual methods are used to identify different portions of an image and then to apply correction operations to these isolated portions according to the desired change. Such manual manipulations on digital images require skill and are often tedious and time consuming. When more and more images are becoming digital, the effort needed to manually manipulate a digital image presents a significant obstacle to effective processing of digital images.

### BRIEF DESCRIPTION OF THE DRAWINGS

The inventions presented herein are described in terms of specific exemplary embodiments which will be described in detail with reference to the drawings. These embodiments are non-limiting exemplary embodiments, in which like reference numerals represent similar parts throughout the several views of the drawings, and wherein:

FIG. 1 depicts a high level architecture of an embodiment of the present invention;

FIG. 2 depicts a high level block diagram of an automated feature-based image correction mechanism of an embodiment of the present invention;

FIG. 3 shows exemplary features in an image;

FIG. 4 illustrates exemplary different image feature types;

FIG. 5 is an exemplary flowchart for a process, in which feature-based image correction is performed, according to an embodiment of the present invention;

FIG. 6 depicts an exemplary construct of a feature description according to an embodiment of the present invention;

FIG. 7 shows an exemplary construct of correction parameters for a feature according to an embodiment of the present invention; and

FIG. 8 is an exemplary flowchart for a feature-based correction unit according to an embodiment of the present invention.

### DETAILED DESCRIPTION

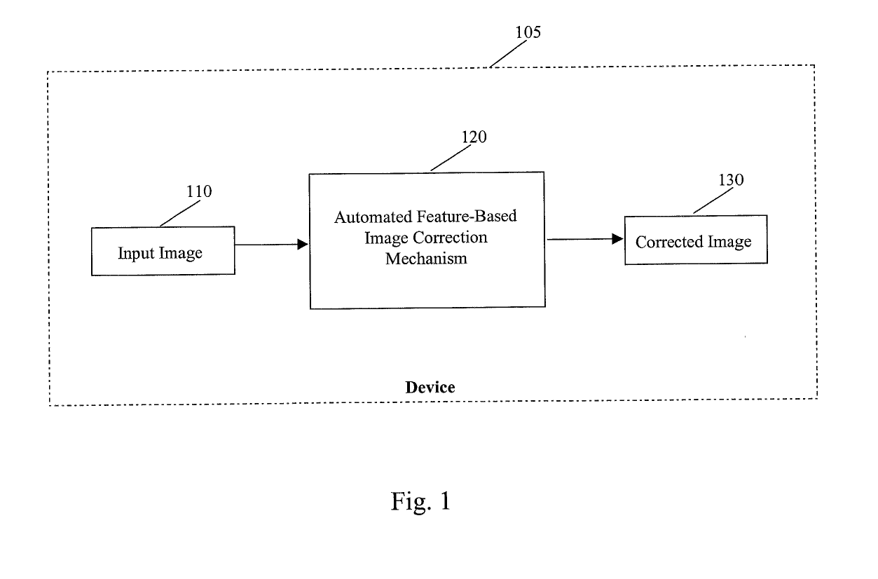

FIG. 1 depicts a high level architecture of an embodiment of the present invention. In FIG. 1, an automated feature-based image correction mechanism 120 is provided in a computing device 105 and performs one or more feature-based image correction operations on an input image 110 to produce a corrected image 130. As will be apparent to those skilled in the art, the corrections may be made to the actual input image to generate the corrected image; two versions or copies of the image are not necessarily required. The computing device 105 may include a personal computer, a laptop, a hand held device, or a camera. The computing device 105 may have some storage space.

The input image 110 may be supplied to the computing device 105 or may be generated by the computing device 105. For example, an input image may be read in by a personal computer through, for instance, an e-mail attachment or a wired/wireless connection to a digital camera. In this case, the input image may be stored in the personal computer (i.e., computing device 105) prior to feature-based image correction. The input image 110 may also be formed within the computing device 105. For example, the input image 110 may be formed within a digital camera.

In FIG. 1, the input image 110 is processed by the automated feature-based image correction mechanism 120 and is automatically corrected with respect to a set of specified image features. As understood herein, correction is not necessarily limited to correct a technical deficiency of the image and/or image feature; correction may also include, but is not limited, to adjusting, enhancing and in any other way modifying the image and/or image feature characteristics whether for technical or aesthetic purposes. To perform such processing, the set of specified image features is identified by the automated feature-based image correction mechanism 120. For example, a specified image feature may correspond to a human face, a building, an animal, etc. Using the human face example, to perform feature-based image correction, occurrences of a human face in the input image 110 are detected. The correction may then be performed based on the characteristics of the detected image features. Different types of image features may be defined in the input image 110. For instance, buildings may also be defined as an image feature in addition to a human face. Furthermore, each image feature type (e.g., human face) may have more than one occurrence in a single input image (e.g., multiple faces in the same picture).

Feature-based image correction is performed based on detected image features. One or more correction operations may be defined on the entire input image and performed with respect to characteristics of detected image features. When image correction is to be performed on the entire input image 110, the correction operation may be executed based on statistical properties of detected image features. For example, the overall contrast of the input image 110 may be re-scaled (i.e., corrected) so that the contrast within the detected human faces reaches a specified level of contrast.

Correction operations may also be defined on individual image features. For example, a correction operation that maximizes the intensity dynamic range may be defined as the correction operation to be performed on the entire input image according to the contrast of detected human faces. Similar correction operations may also be applied only to the detected human faces.

One or more types of correction operations may also be defined for each image feature. For example, both contrast and brightness may be corrected for a specific image feature such as a human face. Further, when one or more correction operations are applied to individual image features, different types of correction operations may be applied to different image features. For example, maximizing the intensity dynamic range (i.e., enhance the contrast) may be performed on a human face image feature and a different correction operation that increases the brightness may be applied to the image feature that represents the sky.

The one or more correction operations performed on different occurrences of a same image feature type (e.g., different human faces) may also differ and may be controlled by one or more operational parameters. For example, the intensity dynamic range used for correcting a particular human face may be determined according to the size of the face detected. The larger the face (e.g., closer to the camera), the larger the dynamic range that may be used (so that the face can be seen more clearly).

Different image features may also be considered with different importance. For example, human faces may be considered as more important than buildings in the input image 110. To accomplish this for example, weights may be assigned to different image features to specify their relative importance. Such weights may be used to control the correction parameter(s) during the correction. For instance, if the correction operation of maximizing intensity dynamic range is applied to both human faces and buildings and a human face feature has a higher weight than a building feature, the intensity dynamic range used for correcting human faces in an image may be larger (corresponding to higher contrast) than that used for correcting buildings in an image. In this way, the human faces may be corrected so that they become more visible than buildings.

The corrected image 130 in FIG. 1 is generated by the automated feature-based image correction mechanism 120. Compared with the input image 110, the corrected image 130 comprises (in most circumstances) the same image features but may have some of the visual properties of the entire image or some of the image features corrected. For example, a corrected image may have different intensity dynamic ranges so that all human faces have substantial contrast. When the automated feature-based image correction mechanism 120 corrects only individual image features, other portions of the corrected image 130 may remain the same as in the input image 110.

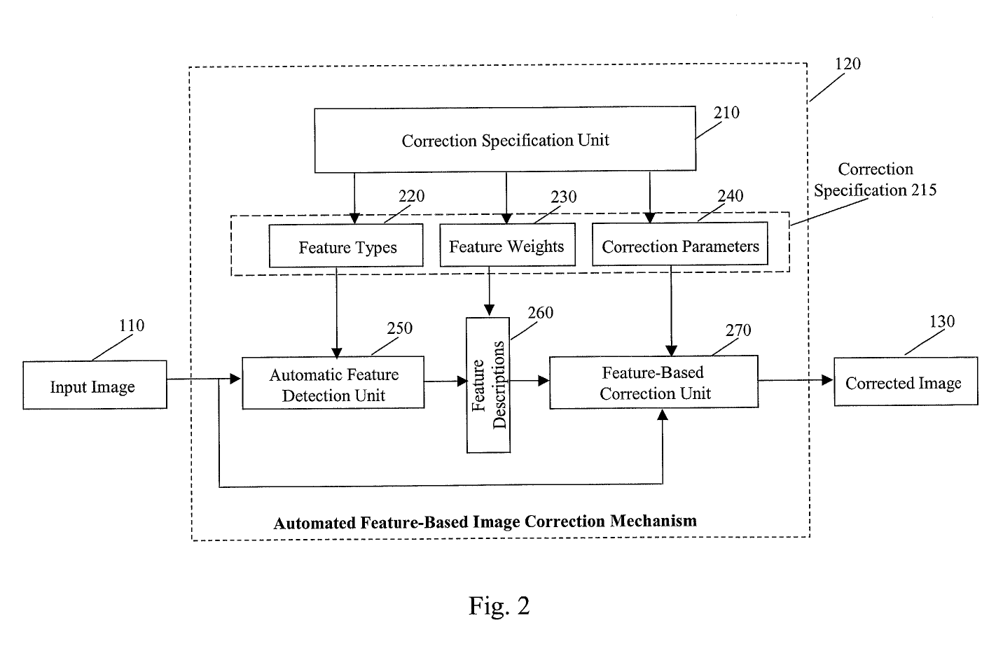

FIG. 2 depicts the internal structure of an automated feature-based image correction mechanism 120 in relation to the input image 110 and the corrected image 130, according to an embodiment of the present invention. In FIG. 2, the automated feature-based image correction mechanism 120 comprises a correction specification unit 210, an automatic feature detection unit 250, and a feature-based correction unit 270. The correction specification unit 210 in FIG. 2 sets up a correction specification 215, which provides configuration parameters that are needed for performing feature-based image correction. Such configuration parameters may include one or more feature types 220, one or more feature weights 230, and one or more correction parameters 240. The feature type(s) 220 specifies the type of image feature(s) to be detected. The feature weight(s) 230 indicates the relative importance of specified image feature types. The correction parameter(s) 240 defines the correction operation(s) and the operational parameter(s) used during the correction operation(s).

The configuration parameter(s) specified via the correction specification unit 210 may be defined prior to the correction operation(s). For example, if the device 105 corresponds to a camera (in this case, the automated feature-based image correction is provided inside the camera), configuration parameters related to automated feature-based image correction may be set up before the camera is used to take an image so that images are produced with specified visual properties corrected. Similarly, if the automated feature-based image correction mechanism 120 is provided on a personal computer, the configuration parameters may be specified prior to applying image correction to an input image.

In operation, the automated feature detection unit 250 detects, from the input image 110, the types of image features that are specified by the feature types 220. Such feature detection may be performed using any technique or algorithm for detecting features in an image as should be known to those skilled in the art. For each detected image feature, the automated feature detection unit 250 may construct a corresponding feature description 260. A feature description may characterize the visual properties of the corresponding detected image feature(s). Such characterization may include the location, the size, or the statistical properties (e.g., average intensity or minimum and maximum intensity values) of the detected image feature. Based on the feature description 260, the feature-based correction unit 270 performs one or more specified correction operations according to the correction parameter(s) 240.

When a correction operation is applied to the entire input image, the statistical properties of the detected features may be used to determine how the overall correction may be performed. For example, the intensity dynamic ranges of all the detected human faces may be used to determine how the intensity dynamic range of the entire input image should be corrected so that the contrast within these faces can be enhanced. When a correction operation is applied to an individual image feature, the correction performed on the image feature may be based on both the specified correction parameter(s) 240 as well as the feature weight 230 (if such weight is specified for the image feature).

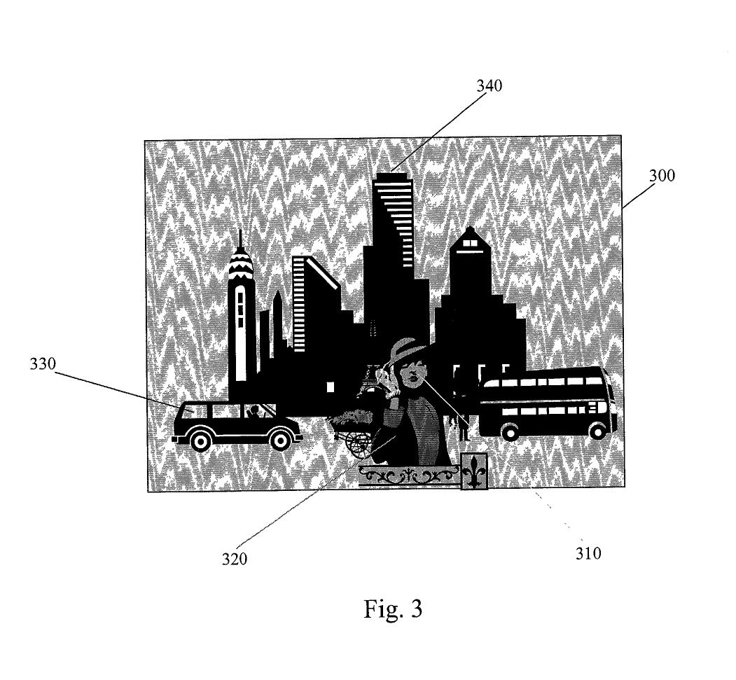

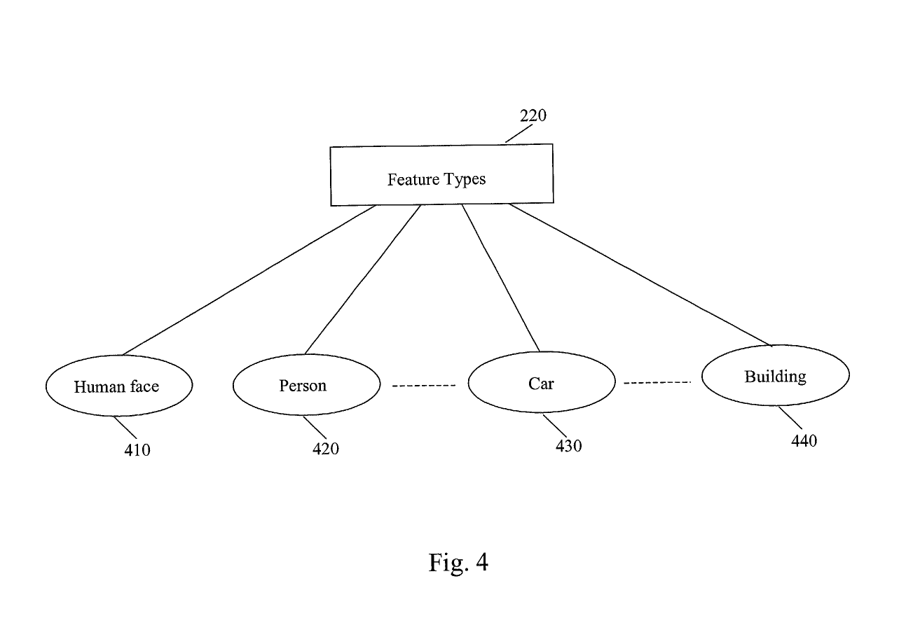

FIG. 3 shows an example image 300 with various exemplary image features. Image 300 comprises a human face 310, a person 320, a car 330, and a tall building 340. When such features are detected from image 300, different correction operations may be applied to each image feature type. The correction operation(s) applied may be determined according to application needs. For example, if the image is a family photo, it may be important to see the person's face clearly. In this case, the corresponding correction operation(s) that can achieve that (e.g., maximize the intensity dynamic range) may be applied to the human face features. To improve the contrast of the human face 310, the dynamic range of the entire image 300 may be corrected so that the dynamic range of the human face 310 can be increased. FIG. 4 shows an example specified group of image feature types that includes human face 410, person 420, car 430, and building 440.

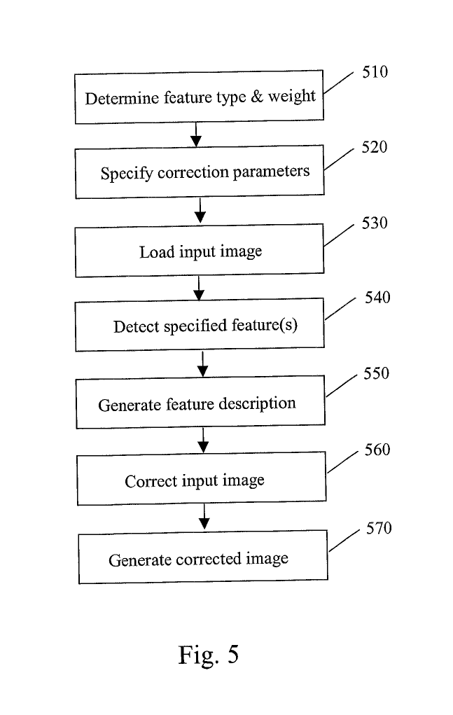

FIG. 5 is an exemplary flowchart for an automated feature-based image correction mechanism 120 according to an embodiment of the present invention. In FIG. 5, prior to performing one or more correction operations, various configuration parameters are specified. Image feature types to be detected and the associated weights (if any) are specified 510. The correction parameters are also specified 520. During the correction operation, an input image is loaded 530. According to the specified configuration parameters, the specified image features are detected 540 and the feature descriptions corresponding to the detected image features are generated 550. Such feature descriptions are then used to correct 560 the input image 110. The correction operation(s) may be performed on either individual features or on the entire input image. The correction is made in accordance with the specified correction parameters and the detected image features. The corrected image is then generated 570.

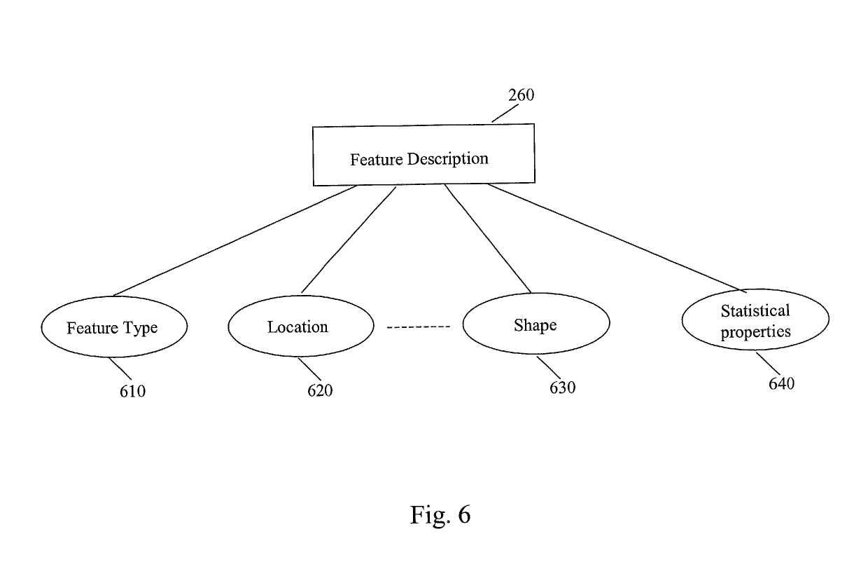

FIG. 6 illustrates an example construct of a feature description 260 of an embodiment of the present invention. A feature description is used to characterize one or more detected instances of an image feature. In FIG. 6, a feature description 260 includes a feature type 610, a location descriptor 620, a shape descriptor 630, and statistical properties 640 of the image feature. An image feature corresponds to an area in the input image 110. Such an area may occupy a region of an arbitrary shape at a certain location in the image. For example, a detected human face is located somewhere in an image and the location of that face may be described using a center point of the face. In addition, a human face normally has an elongated shape, which may be characterized by a curve along the boundary of the human face, representing the precise shape of the detected face. Furthermore, statistics about the visual properties of the face may be computed within the boundary of the detected face. Such descriptions may be used to determine where and how to apply one or more specified correction operations.

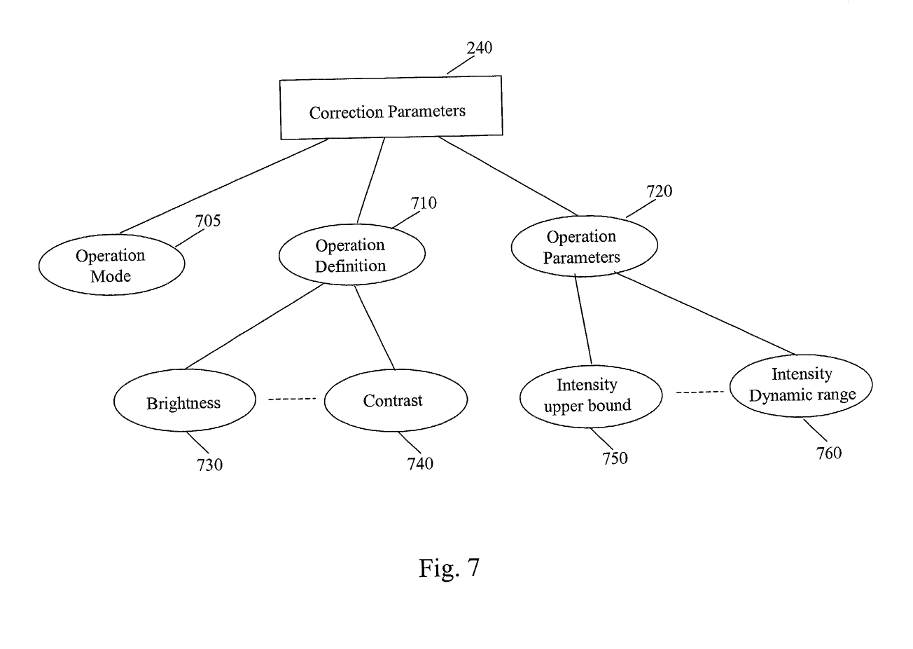

FIG. 7 shows an example construct of the correction parameters 240 according to an embodiment of the present invention. Each correction operation is defined by both an operation mode 705 and an operation definition 710. The operation mode 705 may specify whether the correction operation is applied to the entire image or to individual image features. The operation definition 710 defines the correction to be performed. For example, a correction operation may be defined as increasing the brightness 730 (of either the entire image or an image feature or both, depending on the operation mode 705). A correction operation may also be defined as enhancing the visual contrast 740 (of either the entire image or an image feature or both, depending on the operation mode 705).

For each defined correction operation, one or more operational parameters 720 may be specified. For example, to perform the correction operation of enhancing the brightness 730 of an image feature, an intensity upper bound 750 may be specified as an operational parameter so that the brightest intensity in the corrected image feature will not exceed the defined upper bound. Such upper bound may be specified, for example, as a function of statistical properties of one or more image features in the input image 110. As another example, to enhance the contrast 740 of an image feature, an intensity dynamic range 760 may be specified as an operational parameter so that the contrast in the detected image feature will be scaled to the specified dynamic range. Similarly, the specified dynamic range 760 may be defined as a function of statistical properties of one or more image features detected from the input image 110. The operational parameter(s) may also specify that different occurrences of a same image feature type (e.g., different human faces) in an image receive a differing correction operation. For example, the intensity dynamic range used for correcting a particular human face may be determined according to the size of the face detected. The larger the face (e.g., closer to the camera), the larger the dynamic range that may be used (so that the face can be seen more clearly).

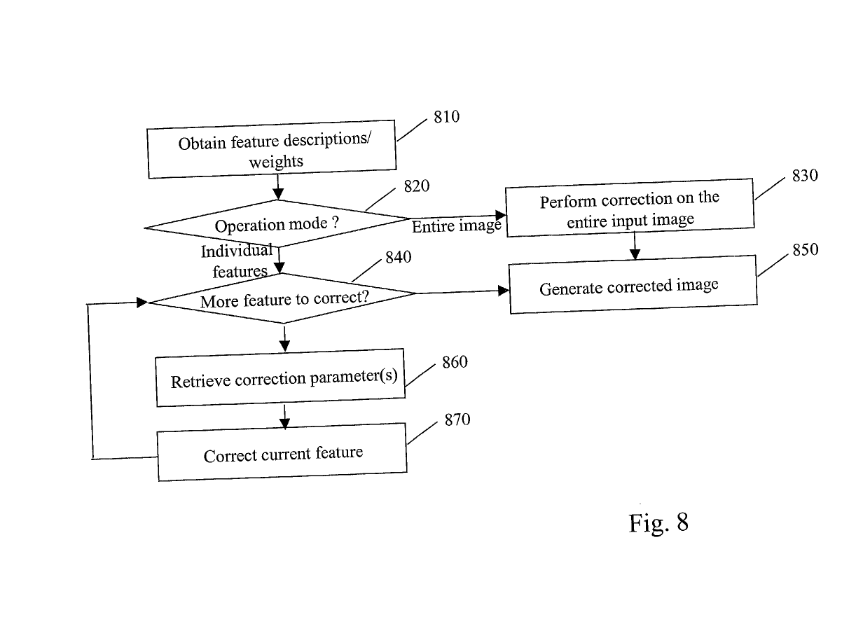

FIG. 8 is an example flowchart for the feature-based correction unit 270 according to an embodiment of the present invention. When the feature-based correction unit 270 is activated, it obtains 810 one or more feature descriptions 260 (generated by the automated feature detection unit 250) and the associated weight(s) 230 (if defined). Each feature description 260 may correspond to one detected image feature. As the feature-based correction unit 270 may perform the feature-based correction operation(s) on either the entire input image or on individual detected image features, the feature-based correction unit first examines the operation mode to determine whether the correction operation(s) is to be performed on the entire image or on individual features 820.

If the correction operation(s) is to be performed on the entire image, the feature-based correction unit 270 corrects the input image 830. This may include retrieving the specified correction parameters (if any) and computing additional operational parameters (if necessary) based on the statistical descriptions of the image features, based on which image correction operation(s) is performed. The correction operation(s) produces 850 the corrected image 130.

If the correction operation(s) is to be performed on individual image features, the feature-based correction unit 270 may correct one feature at a time. For each detected image feature, the corresponding correction parameters are retrieved 860. The correction operation(s) is then performed 870 on each image feature according to specified weight and correction parameters. When all the image features are corrected 840, the corrected image is generated 850.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the present invention is not limiting of the present invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the present invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the present invention described herein; the operations are machine operations. Useful machines for performing the operations of the present invention include general purpose digital computers, special purpose computer or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a microprocessor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations (or operations) described herein without departing from the spirit of the invention. For instance, in certain cases, the operations may be performed in differing order, or operations may be added, deleted or modified.

An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to preferred embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the present invention is not intended to be limited to the embodiments shown above but rather is to be accorded the widest scope consistent with the principles and novel features disclosed in any fashion herein.

What is claimed is:

1. A system for feature-based image correction, comprising:
an automatic feature detection unit to detect a feature from an input image according to a correction specification and to generate a feature description for the detected feature; and
a feature-based correction unit to correct the input image based on the feature description and the correction specification and to generate a corrected image.

2. The system according to claim 1, wherein the correction specification includes a feature type that defines the feature to be detected and corrected and at least one of:
a weight applied to the feature; and
a correction parameter for the feature.

3. The system according to claim 1, wherein the feature-based correction unit corrects only the detected feature in the input image.

4. The system according to claim 1, wherein the feature description includes at least one of:
a feature type
a location descriptor;
a shape descriptor; and
statistical properties.

5. A device, comprising an automatic feature-based image correction mechanism for generating a corrected image based on an input image, the automatic feature-based image correction mechanism automatically detecting a predetermined feature from the input image and correcting the detected feature according to a correction specification.

6. The device according to claim 5, wherein the correction specification comprises:
a feature type; and
one or more correction parameters that define a correction operation.

7. The device according to claim 6, wherein the correction operation is at least one of contrast correction and brightness correction.

8. A method for correcting an image based on one or more image features, comprising:
detecting one or more image features from the image; and
correcting the image according to a correction specification based upon the one or more image features.

9. The method according to claim 8, further comprising generating a feature description for the one or more image features and correcting the image according to the feature description.

10. The method according to claim 8, wherein the correction specification comprises:
a feature type; and
one or more correction parameters that define a correction operation.

11. The method according to claim 10, wherein the correction operation is at least one of contrast correction and brightness correction.

12. A method for feature-based image correction, comprising:
detecting a feature from an input image according to a correction specification;
generating a feature description for the feature; and
correcting the input image based on the correction specification and the feature description to generate a corrected image.

13. The method according to claim 12, wherein the feature description includes at least one of:
a location of the feature;
a shape of the feature;
statistical properties of the feature; and
a feature type of the feature.

14. The method according to claim 12, further comprising setting up the correction specification, the setting up including:
determining a feature type for the feature; and
specifying a correction parameter for the feature, the correction parameter being determined according to the corresponding feature type of the feature.

15. The method according to claim 14, wherein the feature type includes a human face.

16. The method according to claim 14, wherein the correction parameters include at least one of:
operation mode;
operation definition; and
operation parameters.

17. The method according to claim 16, wherein the operation mode includes at least one of:
correcting the entire image; and
correcting the feature.

18. The method according to claim 16, wherein the operation definition includes at least one of brightness correction and contrast correction.

19. The method according to claim 16, wherein the operation parameters include intensity dynamic range.

20. The method according to claim 14, further comprising assigning a weight to the feature and wherein the weight is used to control the operational parameter during correcting the input image.

21. A computer program product including computer program code to cause a computer to perform a method for correcting an image based on one or more image features, the method comprising:
detecting one or more image features from the image; and
correcting the image according to a correction specification based upon the one or more image features.

22. The computer program product according to claim 21, the method further comprising computer program code to perform generating a feature description for the one or more image features and correcting the image according to the feature description.

23. The computer program product according to claim 21, wherein the correction specification comprises:
a feature type; and
one or more correction parameters that define a correction operation.

24. The computer program product according to claim 23, wherein the correction operation is at least one of contrast correction and brightness correction.

25. A computer program product including computer program code to cause a computer to perform a method for feature-based image correction, the method comprising:
detecting a feature from an input image according to a correction specification;
generating a feature description for the feature; and
correcting the input image based on the correction specification and the feature description to generate a corrected image.

26. The computer program product according to claim 25, wherein the feature description includes at least one of:
a location of the feature;
a shape of the feature;
statistical properties of the feature; and
a feature type of the feature.

27. The computer program product according to claim 25, the method further comprising setting up the correction specification, the setting up including:
determining a feature type for the feature; and
specifying a correction parameter for the feature, the correction parameter being determined according to the corresponding feature type of the feature.

28. The computer program product according to claim 27, wherein the correction parameters include at least one of:
operation mode;
operation definition; and
operation parameters.

29. The computer program product according to claim 28, wherein the operation mode includes at least one of:
correcting the entire image; and
correcting the feature.
